(19) United States
(12) Patent Application Publication
(10) Pub. No.: US 2013/0341058 A1
(43) Pub. Date: Dec. 26, 2013

(54) POWER TOOL

(71) Applicant: Heiko ROEHM, Stuttgart (DE)

(72) Inventor: Heiko ROEHM, Stuttgart (DE)

(73) Assignee: Robert Bosch GmbH, Stuttgart (DE)

(21) Appl. No.: 13/925,088

(22) Filed: Jun. 24, 2013

(30) Foreign Application Priority Data
Jun. 25, 2012 (DE) 102012210746.0

(51) Int. Cl. B25F 5/00; B25F 5/02

(52) U.S. Cl. CPC B25F 5/00; B25F 5/001; B25F 5/02
USPC 173/178; 173/217; 173/183

(57) ABSTRACT

A power tool having an electric motor with a static stall torque and a housing, a tool holder being mounted on the housing rotatably about an axis of rotation, the electric motor being connected to the tool holder, a handle for an operator being provided on the housing, the handle having a handle length, characterized in that the ratio of the static stall torque to the handle length is greater than 400 Nm/m.

### RELATED APPLICATION INFORMATION

The present application claims priority to and the benefit of German patent application no. 10 2012 210 746.0, which was filed in Germany on Jun. 25, 2012, the disclosure of which is incorporated herein by reference.

### FIELD OF THE INVENTION

The present invention relates to a power tool.

### BACKGROUND INFORMATION

Various power tools having an electric motor with a static stall torque and a housing are known from the related art, a tool holder being mounted on the housing rotatably about an axis of rotation, the electric motor being connected to the tool holder, a handle for an operator being provided on the housing, the handle having a grip length.

### SUMMARY OF THE INVENTION

An object of the present invention is to provide a high performance and compact power tool.

The object of the present invention is achieved by the power tool according to the description herein.

Additional advantageous specific embodiments of the present invention are described in the further descriptions herein.

According to the present invention, the power tool has an electric motor having a static stall torque and a housing, a tool holder being mounted on the housing rotatably about an axis of rotation. The electric motor is connected to the tool holder, a handle for an operator being provided on the housing. This handle has a grip length, the ratio of the static stall torque to the grip length being greater than 400 Nm/m. A compact power tool supplying a high stall torque is made available in this way.

In another specific embodiment, the grip length is measured as the distance from the axis of rotation in meters. Furthermore, the static stall torque is measured in Newton meters.

In another specific embodiment a predefined end distance is subtracted from the grip length, the end distance may be in the range of 0.04 m for a grip length. This permits an accurate delimitation of the ratio.

In another specific embodiment the power tool has two handles for two-handed holding, the two handles forming an angle between 160° and 200°, for example, 180° to one another. In this specific embodiment, the sum of the two grip lengths is used as the grip length. When the end distance is taken into account, the end distance is subtracted from each grip length before forming the sum.

In another specific embodiment, the power tool has two handles for two-handed holding, the two handles forming an angle of less than 160°, which may be less than 90° to one another. In this specific embodiment, the longest grip length is used as the grip length.

In another specific embodiment, a sensor is situated in the housing, the sensor being configured to recognize rotation of the housing, the torque of the electric motor being reduced at least when the sensor detects rotation of the housing in excess of a predefined limiting value.

Detecting the rotation of the housing permits a simple but reliable detection of an excessively high torque of the power tool. It is therefore possible to reliably detect and prevent delivery of an excessively high torque by the power tool. It is thus possible to prevent injuries to the operator. Smaller power tools having higher possible torques may thus be made available through the method proposed here. In addition, a mechanical torque limiting clutch may be omitted. Due to the use of the rotation or rotational acceleration as a measure of the applied torque, overstressing of the operator is recognizable using a relatively simple arrangement. The torque limitation is thus inexpensive and may be reliably implemented.

In one specific embodiment, the electric motor is switched to currentless for reducing the torque. This type of torque limitation is simple and may be reliably implemented.

In another specific embodiment, the electric motor is decelerated for reducing the torque. This achieves a defined torque limitation.

In another specific embodiment, a rotational acceleration is detected as rotation. Detecting the rotational acceleration permits a more accurate estimation of the torque, so that a more precise shutdown is possible if the torque becomes too high. The sensor may be configured as an acceleration sensor or as a rotation rate sensor.

In another specific embodiment, a predefined angle of rotation between 40° and 100°, in particular in the range of 70°, is used as the limiting value. The angle of rotation range from 40° to 100° permits reliable detection of an excessively high torque.

In another specific embodiment, acceleration by a predefined angle of rotation within a predefined period of time, in particular in 0.7 second or less, for example, in the range of 0.5 second, is used as the limiting value for the rotation. Use of the acceleration makes it possible to attenuate the surprise.

In another specific embodiment, the power tool is supplied from a rechargeable energy source, in particular a lithium ion rechargeable battery. The method described here may be used for effective limitation of the torque, in particular with lithium ion rechargeable batteries.

The present invention is explained in greater detail below with reference to the figures.

### BRIEF DESCRIPTION OF THE DRAWINGS

FIG. 1 shows a schematic diagram of a power tool,

FIG. 2 shows a circuit configuration of the power tool,

FIGS. 3 through 5 show power tools having one handle, and

FIGS. 6 through 8 show power tools have two handles.

### DETAILED DESCRIPTION

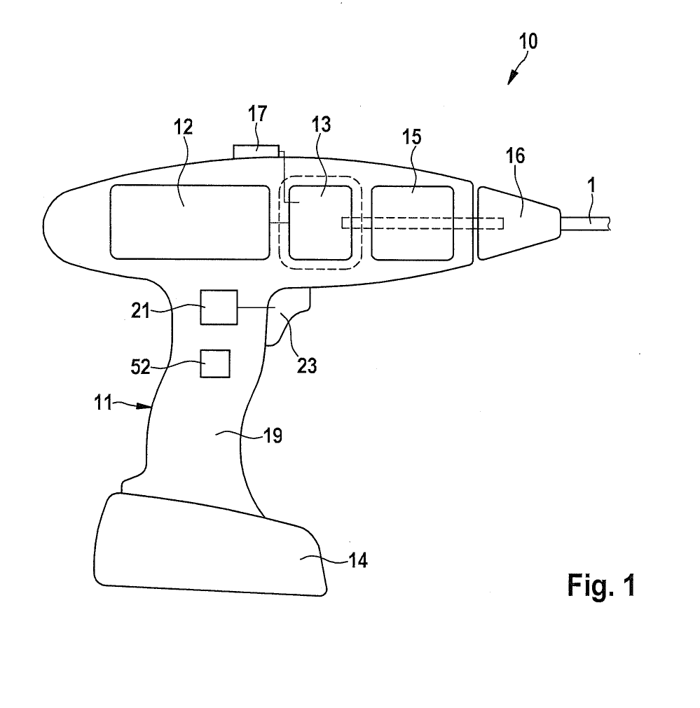

FIG. 1 shows a hand-held power tool 10. Power tool 10 may be, for example, a screwdriver, a combi drill, an impact drill or any other type of power tool in which an electric motor 12 is used to operate a tool 1, electric motor 12 being supplied with electricity from a rechargeable energy source 14. Rechargeable energy source 14 is configured as a rechargeable battery, for example, in particular as a lithium ion rechargeable battery. However, other types of rechargeable batteries may also be used, depending on the chosen specific embodiment. The tool holder is configured as a drill chuck or as an SDS system. In the exemplary embodiment shown here, energy source 14 is detachably connected to a housing 11 of power tool 10.

In the specific embodiment shown here, energy source 14 is detachably attached at a lower end of a handle 19. An operating element 23 is provided on housing 11. Operating element 23 is used for operating, i.e., switching electric motor 12 on and off. Operating element 23 is configured as a movable button in the specific embodiment shown here and is connected to a switch 21. Switch 21 controls the power supply to electric motor 12 from energy source 14. Electric motor 12 is connected to a tool holder 16 via a gear 13 and a torque clutch 15. A tool 1, for example, a drill or a screwdriver, may be inserted into tool holder 16. Furthermore, a gear switch 17 may be provided for setting the ratio of gear 13. Power tool 10 has a circuit 52.

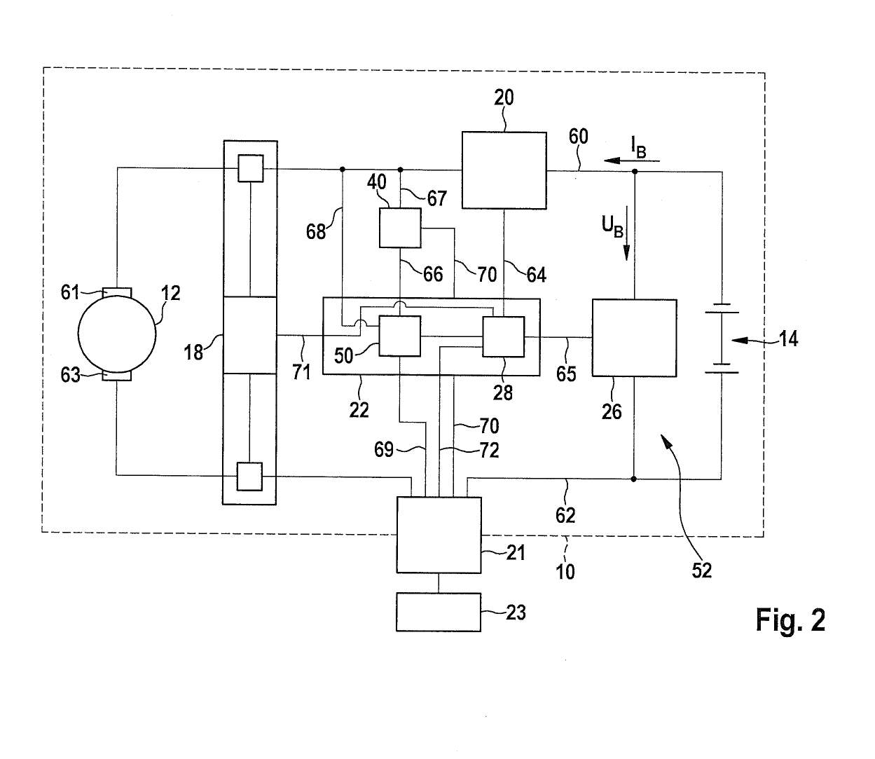

FIG. 2 shows circuit 52 of power tool 10 in detail. Energy source 14 is connected to a first terminal 61 of electric motor 12 via a first current path 60, via a current measuring element 20 and a regulating device 18. A second pole of energy source 14 is connected to a second terminal 63 of electric motor 12 via a second current path 62, via switch 21 and regulating device 18. A voltage measuring device 26 is provided in parallel with the two poles of energy source 14. Voltage measuring device 26 and current measuring element 20 are each connected to a monitoring unit 22 via sensor lines 64, 65. Monitoring unit 22 has a control unit 28 and an evaluation unit 50. In addition, a sensor 40, which is connected to evaluation unit 50 via a third sensor line 66, is also provided. Sensor 40 may be configured as an acceleration sensor or as a rotation rate sensor, for example, and may detect a movement of the housing and transmit this to evaluation unit 50 of monitoring unit 22. The result from evaluation unit 50 is relayed to control unit 28. Sensor 40 and evaluation unit 50 are each connected to first current path 60 via a first and a second current line 67, 68. In addition, sensor 40 and evaluation unit 50 are each connected to second current path 62 via a third and fourth current line 69, 70 via switch 21.

Regulating device 18 is connected to control unit 28 via a control line 71. Regulating device 18 is configured to relay the current of first current path 60 to first terminal 61 and to relay the current from second terminal 63 to switch 21 or to change the direction of the current, i.e., to apply first current path 60 to second terminal 63 of electric motor 12 and to apply second current path 62 to first terminal 61 of electric motor 12. Furthermore, the regulating device may carry out a deceleration of electric motor 12, for example, by short circuiting the two terminals 61, 63.

The corresponding circuit states of regulating device 18 are predefined by control unit 28. Monitoring unit 22 ascertains with the aid of evaluation unit 50 and sensor 40, for example, whether a predefined rotation or a predefined rotational acceleration of the housing representing a spontaneous increase in torque of a working case has been exceeded. For this purpose, sensor 40, which is configured, for example, as a rotation rate sensor and/or as an acceleration sensor, monitors the movement of the housing and reports this to evaluation unit 50. Evaluation unit 50 compares the resulting sensor signal with a limiting value. If the limiting value is exceeded, evaluation unit 50 signals this to control unit 28.

For example, a predefined angle of rotation between 40° and 100°, in particular 70°, may be used as the limiting value. Furthermore, a rotational acceleration by a predefined angle of rotation within a predefined period of time, in particular in 0.7 second or less, for example in the range of 0.5 second, may be used as the limiting value. The limiting values may deviate from the examples described here, depending on the specific embodiment.

If control unit 28 detects that a limiting value has been exceeded, for example, a predefined rotation or acceleration, then control unit 28 triggers regulating device 18 in such a way that the torque of the electric motor is at least reduced. For this purpose, for example, regulating device 18 reverses the direction of the current through motor 12, so the direction of rotation of electric motor 12 is reversed. After electric motor 12 comes to a standstill and before it ramps up with a different direction of rotation, control unit 28 may turn off the electric motor. Thus a startup of the power tool controlled by the operator is ensured.

Alternatively, rapid braking, for example, through short-circuit operation of electric motor 12 or an adequate method, is prompted by regulating device 18.

The torque is also reduced even though the operator is still depressing the operating element 23 and a desired actuation of the power tool is indicated.

Sensor 40 and evaluation unit 50 draw current from energy source 14. Switch 21 is configured in such a way that the power supply of sensor 40 and/or the power supply of evaluation unit 50 is/are interrupted by an interruption in the power supply of electric motor 12 due to the operating element 23 being released. This is the case, for example, when the operator indicates whether the electric motor is to be turned off by a corresponding actuation or nonactuation of operating button 23.

In addition, control unit 28 is connected to switch 21 via a second control line 72. If control unit 28 recognizes by voltage measuring device 26 that the voltage of energy source 14 falls below a defined lower voltage level and thus damage is to be expected in the case of a lithium ion rechargeable battery, then switch 21 is triggered by control unit 28 in such a way that switch 21 switches the electric motor and sensor 40 and/or evaluation unit 50 to currentless. Again in this specific embodiment, the power supply to sensor 40 and/or the power supply to evaluation unit 50 is/are interrupted.

Depending on the chosen specific embodiment, sensor 40 and/or monitoring unit 22 may also be situated in battery pack 14.

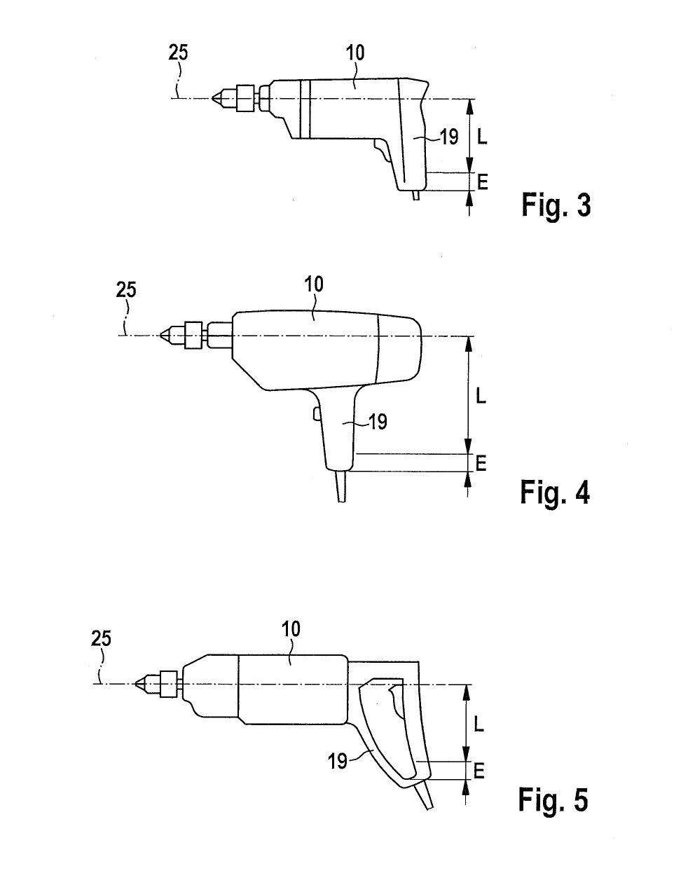

FIGS. 3 through 5 show various specific embodiments of power tools 10 having one handle 19. Energy source 14 is not shown explicitly in the specific embodiments illustrated here. Handles 19 each have an effective length L with respect to axis of rotation 25 of tool holder 16. Effective length L is the area of handle 19 which is the farthest away from the axis of rotation of tool holder 16 and may still be gripped by an operator and used as a handle. It is therefore necessary to subtract an end section E of the actual length of the handle from the total length of handle 19. End section E may be in the range between 0.02 m and 0.6 m, for example, 0.04 m. FIG. 3 shows a power tool in which handle 19 is situated at the end of housing 11. FIG. 4 shows a power tool in which handle 19 is situated approximately at the center of the housing. FIG. 5 shows a power tool having a handle 19 situated at the end of the power tool and configured as a bow-type handle.

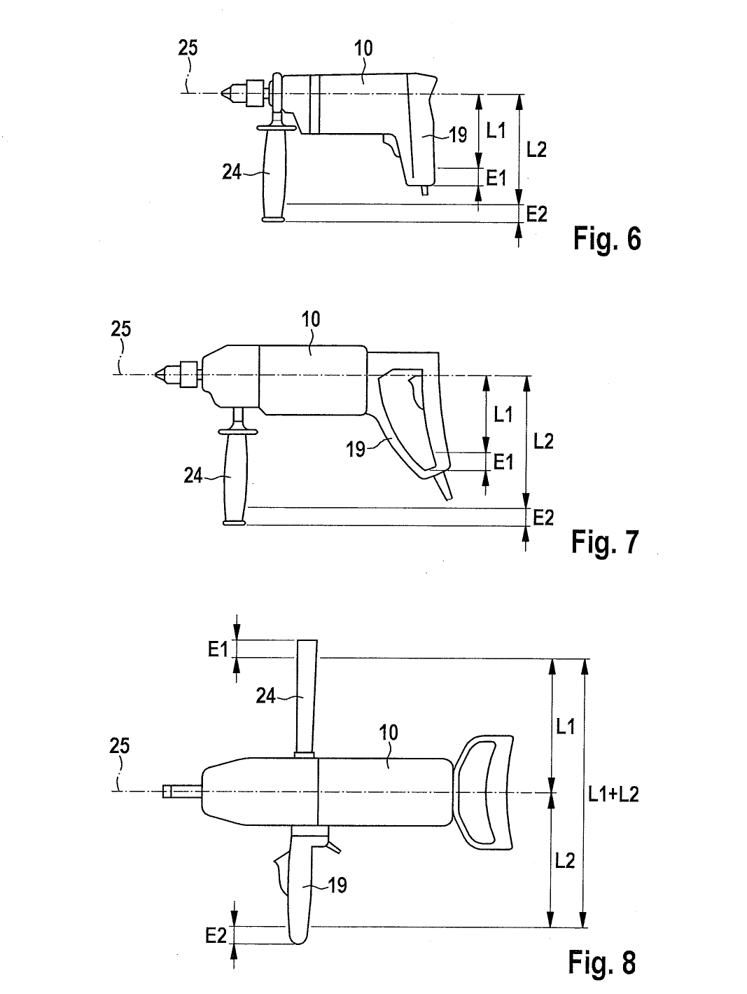

FIGS. 6 through 8 show additional specific embodiments of power tools in which two handles 19, 24 are provided on each. Three handles are even provided in the specific embodiment in FIG. 8. Each handle has a handle length L1, L2 and a corresponding end section E1, E2. In the specific embodiment in FIGS. 6 and 7, in which the handles are at the same angle to the axis of rotation, i.e., are in the same plane, the longest of the two handles 19, 24 is used for the handle length. In the specific embodiment of FIG. 6, second handle 24 having handle length L2 is the handle having the greater effective handle length than handle 19 for holding the power tool.

FIG. 7 shows handle 19 as a bow-type handle. Again in this specific embodiment, second handle 24 has the greater effective length L2 for holding the tool.

In the specific embodiment of FIG. 8 the first and second handles 19, 24 are situated at an angle of more than 160° to axis of rotation 25 of tool holder 16. The first and second handles 19, 24 may be situated in a plane. In this specific embodiment, the sum of effective handle lengths L1, L2 of two handles 19, 24 is used as the effective handle length.

In the specific embodiments of FIGS. 6 through 8, second handles 24, for example, are removable and to be declamped from the power tool by releasing a simple clamp connection.

The static stall torque or the slip torque of a clutch is measured by measuring the stall torque of the driven tool holder (spindle) of the power tool in a cold state (e.g., 20° C.). The slip torque of the clutch replaces the static stall torque when the slip torque is less than the stall torque. If the power tool has several gears, then the lowest rotational speed is set. If a speed controller is provided on the power tool, then the highest rotational speed is used for ascertaining the stall torque or the slip torque of the clutch. Several measurements may be carried out and an average is formed. The stall torque is the torque of the power tool which the power tool may muster when the tool holder is stationary and electric motor 12 is switched on. The clutch torque is the torque at which torque clutch 15 disengages and the operative connection between electric motor 12 and tool holder 16 is opened.

What is claimed is:

1. A power tool, comprising:
an electric motor with a static stall torque and a housing;
a tool holder mounted on the housing rotatably about an axis of rotation, the electric motor being connected to the tool holder;
a handle for an operator being provided on the housing, the handle having a handle length, wherein the ratio of the static stall torque to the handle length is greater than 400 Nm/m.

2. The power tool of claim 1, wherein the handle length is measured as the distance from the axis of rotation in meters and the static stall torque is measured in Newton meters.

3. The power tool of claim 1, wherein a predefined end distance is subtracted from the handle length, the end distance is in the range of 0.04 m for a handle length.

4. The power tool of claim 1, wherein the power tool has two handles for two-handed holding, the two handles forming an angle between 160° and 200° to one another and the sum of the two handle lengths being used as the handle length.

5. The power tool of claim 1, wherein the power tool has two handles for two-handed holding, the two handles forming an angle of less than 160° to one another and the longest handle length being used as the handle length.

6. The power tool of claim 1, wherein a sensor is situated in a sensor housing, the sensor being configured to detect rotation of the housing, further comprising:
a control unit configured to at least reduce the torque of the electric motor when the sensor detects rotation of the housing in excess of a predefined limiting value.

7. The power tool of claim 6, wherein the control unit is configured to switch the electric motor to currentless for reducing the torque.

8. The power tool of claim 6, wherein the control unit is configured to decelerate the electric motor for reducing the torque.

9. The power tool of claim 6, wherein the sensor is configured as an acceleration sensor or as a rotation rate sensor.

10. The power tool of claim 6, wherein the limiting value is a predefined angle of rotation between 40° and 100°, in particular in the range of 70°.

11. The power tool of claim 6, wherein an acceleration by a predefined angle of rotation within a predefined period of time, which is 0.7 second or less, is used as the limiting value.

12. The power tool of claim 1, wherein the power tool is supplied with power from a lithium ion rechargeable battery.

13. The power tool of claim 6, wherein a rechargeable energy source, which is a battery pack, is detachably attached to the housing, the energy source supplying electric power to the electric motor, at least one of the control unit and the sensor being situated on the energy source.

14. The power tool of claim 1, further comprising:
a slip clutch between the motor and the tool holder, at least attenuating the operative connection between the electric motor and the tool holder when a predefined torque is exceeded, and a slip torque of the slip clutch being used instead of the static stall torque when the slip torque is less than the static stall torque.

15. The power tool of claim 1, wherein the power tool has a tool holder configured as a drill chuck or as an SDS system.

16. The power tool of claim 6, wherein an acceleration by a predefined angle of rotation within a predefined period of time, in the range of 0.5 second, is used as the limiting value.
